(19) United States
(12) Patent Application Publication
(10) Pub. No.: US 2026/0364581 A1
(43) Pub. Date: Nov. 19, 2026

(54) CATALYTIC CRACKING CATALYST, PREPARATION METHOD THEREFOR AND USE THEREOF, AND METHOD FOR PROCESSING WAX OIL

(71) Applicant: PETROCHINA COMPANY LIMITED, Beijing (CN)

(72) Inventors: Hongchang DUAN, Gansu (CN); Tao LIU, Gansu (CN); Zhengguo TAN, Gansu (CN); Yunfeng ZHENG, Gansu (CN); Xiaoli HU, Gansu (CN); Tong LU, Gansu (CN); Yi SU, Gansu (CN); Chaowei LIU, Gansu (CN); Li JING, Gansu (CN); Gengzhen CAO, Gansu (CN)

(73) Assignee: PETROCHINA COMPANY LIMITED, Beijing (CN)

(21) Appl. No.: 19/132,492

(22) PCT Filed: Nov. 9, 2023
(86) PCT No.: PCT/CN2023/130675

§ 371 Date: May 23, 2025

(30) Foreign Application Priority Data
Nov. 25, 2022 (CN) 202211493749.5

(51) Int. Cl. B01J 29/08; B01J 37/00; B01J 37/03; B01J 37/04; B01J 37/06; B01J 37/08; B01J 37/30; C10G 11/05

(52) U.S. Cl. CPC B01J 29/088; B01J 37/0009; B01J 37/031; B01J 37/04; B01J 37/06; B01J 37/08; B01J 37/30; C10G 11/05

(57) ABSTRACT

The present invention relates to the technical field of catalysts, and specifically relates to a catalytic cracking catalyst, a preparation method therefor and a use thereof, and a method for processing wax oil. The catalytic cracking catalyst comprises: a modified molecular sieve, a binder, and a matrix material, wherein the modified molecular sieve is prepared by modifying a Y-type molecular sieve, and uses a specific modification treatment process. The catalytic cracking catalyst provided by the present invention has the characteristics of high activity, good stability, high crystallinity, strong wax oil conversion capability, good gasoline selectivity, high total liquid yield, high coke selectivity and the like; additionally, the use of the catalyst for processing wax oil can effectively increase the conversion rate of wax oil and effectively improve the total liquid yield.

### CROSS-REFERENCE TO RELATED APPLICATIONS

The application claims the benefit of the Chinese patent application No. “202211493749.5”, filed on Nov. 25, 2022, the content of which is specifically and entirely incorporated herein by reference.

### FIELD

The present disclosure relates to the technical field of catalysts, in particular to a catalytic cracking catalyst, a preparation method therefor and a use thereof, and a method for processing wax oil.

### BACKGROUND

Catalytic cracking as the primary means for processing heavy oil to obtain light-weight petroleum products has an important significance in petrochemical industries in China, with an annual processing capacity exceeding 200 million tons. Catalyst is the key core technology of catalytic cracking, it can flexibly adjust the product mix, improve the product quality, realize low carbon emission, and efficient conversion of heavy oil, thus the research of catalysts has focused on how to increase the conversion rate of heavy oil, raise the yield of high value-added liquid products, and reduced consumption of the catalysts.

CN113830775A with an application number “202010581809.3” discloses a silicon-aluminum material, a preparation method thereof, and a low-green-coke high-activity heavy oil conversion catalytic cracking catalyst, wherein the anhydrous weight chemical expression of the silicon-aluminum material is (0-1)Na₂O·(15-50)Al₂O₃·(85-50)SiO₂, the maximum pore size is 10-100 nm, the specific surface area is 150-600 m²/g, the pore volume is 0.5-1.5 mL/g, and the pore volume of pores with the pore diameter of more than 10 nm accounts for 70-98% of the total pore volume. The catalytic cracking catalyst has good coke selectivity.

CN114425399A with an application number “202011016356.6” discloses a catalytic cracking catalyst as well as the preparation method and application thereof, the catalytic cracking catalyst contains a cracking activity component, a high-specific-heat-capacity matrix material, clay, and a binder, wherein the high-specific-heat-capacity matrix material contains at least 5% by weight of manganese oxide having a specific heat capacity of 1.3-2.0 J/(g·K). The catalytic cracking catalyst has excellent metal pollution resistance and good heavy oil conversion capacity, is used for heavy oil catalytic cracking, and has high light oil yield.

CN115055203A with an application number “202210859937.9” discloses a heavy oil catalytic cracking catalyst, calculated in terms of weight, which comprises, by weight, 10-40 parts of a zeolite molecular sieve, 5-30 parts of a binder, 1-10 parts of a mesoporous rare earth-magnesium-aluminum ternary composite oxide, and 20-80 parts of clay. The catalytic cracking catalyst has a high heavy oil conversion capacity and excellent heavy metal pollution resistance.

CN101385983A with an application number “200710121664.3” discloses a heavy oil catalytic cracking catalyst, comprising 10-50 wt % of REY-typed molecular sieve on a dry basis, 10-40 wt % of inorganic oxide adhesive calculated in terms of oxide, and 10-70 wt % of clay on a dry basis. The catalyst has strong heavy oil cracking capability, high gasoline yield, and strong Vanadium pollution resistance capability.

Based on the prior art mentioned above, the heavy oil conversion capacity of the catalyst is strongly related to the molecular sieve, matrix property, matching proportion, preparation techniques, and modification elements, but the Y-type molecular sieve remains to play a crucial role; due to its unique three-dimensional channel structure, suitable acidity, and desirable stability, the Y-type molecular sieve is still the major active ingredient of the FCC catalyst, and its properties determine the activity, stability, heavy oil conversion performance, and product selectivity of the catalyst, thus the Y-type molecular sieve is also one of the research hotspots for improving properties of the heavy oil catalyst. The catalytic cracking reaction is typically an acid-catalyzed gas-solid heterogeneous reaction that follows the carbenium ion mechanism, whereas the NaY molecular sieve itself lacks acidity, it usually needs to be subject to the exchanging and modifying process to remove its Na⁺ ions and modify its acidity and pore channel structure. Since the acidity of H⁺ ions in acids is too strong, the Y-type molecular sieve skeleton structure is easily destroyed, resulting in reduced crystallinity and selectivity; the REY-type molecular sieve is apt to deactivate and generate coke during the catalytic cracking reaction process due to its strong acidity and high acid density. Therefore, the commonly used modification method at present is to prepare the modified REHY or REUSY-type molecular sieve having different acidities and pore channel structures, by using ammonium salt and/or rare earth for performing the ion exchange and carrying out the thermal or hydrothermal roasting. The current preparation methods for the REHY or REUSY-type molecular sieve can be roughly divided into two categories: the first method involves the NaY molecular sieve is initially subjected to exchanging of a small mount of rare earth ions and/or ammonium ions, and then roasting to remove the rare earth ions and/or ammonium ions, or performing dealumination treatment to prepare the REUSY molecular sieve; the second method involves with that the NaY molecular sieve is initially turned into the USY molecular sieve, and then exchange with the rare earth ions to prepare the REUSY molecular sieve.

Ammonium chloride is apt to decompose at high temperature and crystallize at low temperature, it is prone to block the catalyst flue and bag dust collector, it causes that the continuous production cannot be implemented; ammonium nitrate will explode under high temperature, high pressure, and the presence of an oxidizable substance (e.g., reducing agent) and electric sparks, ammonium nitrate is a key material in the production of explosives, its price is high, thus ammonium nitrate is not adopted; ammonium sulfate has stable properties and cheap price, it is commonly used in industrial molecular sieve exchange and modification; however, ammonium sulfate tends to form rare earth sulfate precipitates with rare earth, which on one hand causes that the rare earth ions cannot migrate into the molecular sieve cages and effectively stabilize the molecular sieve skeleton structure, and on the other hand, it is apt to cause excessive sulfate radical, disrupt the molecular sieve skeleton structure, and the sulfate radical will be converted to sulfides and corrode the equipment in the refining process after the catalyst is prepared.

In the prior art, the rare earth precipitation method is commonly used for improving the utilization efficiency of the rare earth, and forming the rare earth with an independent phase, enhancing the Vanadium-contamination resistance of the molecular sieves; the rare earth and the ammonium salt are exchanged at the same time, given that there is a competitive exchange, which leads to low exchange efficiency; if the exchange of ammonium salt is performed before the exchange of the rare earth, the use of ammonium chloride and ammonium nitrate may cause the problems such as high cost and corrosion of equipment; if ammonium sulfate with recyclability and low cost is used, for the sake of avoiding the formation of sulfate precipitation, the sulfate radical needs to be washed with a large amount of water, the water consumption will be increased. After the rare earth-modified molecular sieve is subjected to the hydrothermal roasting, it is unavoidable that a portion of rare earth cannot be positioned in the sodalite cage, the exchange with ammonium sulfate is subsequently performed, it causes the precipitation of the rare earth sulfate, as a result, the sulfate radical in the molecular sieve is increased, the crystallinity is reduced. Although pre-exchange can reduce the amount of sodium oxide and sulfate in the modified molecular sieves, it suffers from defects such as a long processing process, high water consumption, and high costs. The REY molecular sieve prepared without the use of ammonium salt exhibits the defect of the high content of green coke.

CN101088613A with an application number “200610087535.2” discloses a preparation process of the REY molecular sieve, the process is used for preparing the one-exchange and one-roasting rare earth modified Y-molecular sieve through the rare earth exchange, precipitation, filtering, roasting, and then directly performing the ammonium salt exchange, thereby preparing the REY molecular sieve; although the rare earth loss is avoided during the exchange process by precipitation, while in the prepared one-exchange and one-roasting rare earth modified Y-molecular sieve, rare earth is inevitably present on the outer surface or super cage space of the molecular sieve, if ammonium sulfate is subsequently used as an exchanger, this part of rare earth is easily reacted with sulfate radical to form the precipitate rare earth sulfate, resulting in high content of sulfate radical, low crystallinity, and poor stability of the molecular sieve.

CN1485137A with an application number “02130783.0” discloses an exchange method of ammonium and rare earth ions for molecular sieve, the method uses ammonium sulfate as the source of ammonium ions, the method can reduce corrosion of equipment by ammonium chloride vapor formed during the process of drying and roasting the molecular sieve, and allow the sufficient use of the industrially recovered ammonium sulfate, so that the industrial production forms a virtuous cycle, but the method has the defects of complex process and high water consumption.

In general, the rare earth-modified molecular sieves in the prior art have defects such as high content of sulfate radical, low crystallinity, corrosion of equipment, long production flow, and high costs; in addition, when the rare earth-modified molecular sieves are used for processing wax oil, there are problems such as low catalytic cracking activity, low conversion rate of wax oil, low total liquid yield, and corrosion of equipment by the sulfide during the application process of converting sulfate radical into sulfide.

### SUMMARY

The present disclosure aims to overcome the aforementioned defects in the prior art and provides a catalytic cracking catalyst, a preparation method therefor and a use thereof, and a method for processing wax oil, the catalytic cracking catalyst has high catalytic activity, stability, and crystallinity when it is used for processing wax oil, it is capable of effectively improving the conversion rate of wax oil and yield of high value-added liquid products.

To achieve the above object, the first aspect of the present disclosure provides a catalytic cracking catalyst comprising a modified molecular sieve, a binder, and a matrix material, wherein the modified molecular sieve is prepared by performing modification treatment to a Y-type molecular sieve;
wherein the modification treatment process comprises the following steps: a. performing rare earth ion exchange on the Y-type molecular sieve to obtain a rare earth ion exchange slurry; b. adding a first precipitating agent to perform a first precipitation on a part of rare earth ions in the rare earth ion exchange slurry to obtain a first precipitation slurry; c. subjecting the first precipitation slurry to a filtering, a first ammonium sulfate exchange, a first water washing, and a first roasting sequentially to obtain a one-exchange and one-roasting molecular sieve dry powder; d. adding a second precipitating agent to perform a second precipitation on a part of rare earth ions in the one-exchange and one-roasting molecular sieve dry powder, then performing a second ammonium sulfate exchange, a second water washing, and an optional second roasting sequentially to prepare the modified molecular sieve.

Preferably, the modified molecular sieve is contained in an amount of 15-50 wt %, the binder is contained in an amount of 5-38 wt %, and the matrix material is contained in an amount of 35-80 wt % in the catalytic cracking catalyst on a dry basis.

Preferably, the modified molecular sieve has a SO₄²⁻ content less than or equal to 1 wt %, more preferably less than or equal to 0.5 wt %, further preferably within the range of 0.01-0.45 wt %.

Preferably, the modified molecular sieve has a Na⁺ content calculated in terms of Na₂O less than or equal to 1.2 wt %, more preferably less than or equal to 1 wt %.

Preferably, the modified molecular sieve has a RE³⁺ content calculated in terms of RE₂O₃ more than or equal to 5 wt %, more preferably within the range of 6-16 wt %.

Preferably, the modified molecular sieve has a C/C₀ ratio more than or equal to 55, further preferably within the range of 55-70.

Preferably, the catalytic cracking catalyst has a Na⁺ content calculated in terms of Na₂O less than or equal to 0.2 wt %, more preferably within the range of 0.05-0.2 wt %.

The second aspect of the present disclosure provides a method for preparing a catalytic cracking catalyst comprising the following steps:
(1) mixing a modified molecular sieve, a binder, a matrix material, and water to obtain a slurry;
(2) subjecting the slurry to homogenizing, molding, and a third roasting sequentially to obtain a catalyst precursor, performing a sodium reduction treatment on the catalyst precursor to prepare the catalytic cracking catalyst;
wherein the modified molecular sieve is prepared by performing modification treatment to a Y-type molecular sieve, and the modification treatment process comprises the following steps: a. performing rare earth ion exchange on the Y-type molecular sieve to obtain a rare earth ion exchange slurry; b. adding a first precipitating agent to perform a first precipitation on a part of rare earth ions in the rare earth ion exchange slurry to obtain a first precipitation slurry; c. subjecting the first precipitation slurry to a filtering, a first ammonium sulfate exchange, a first water washing, and a first roasting sequentially to obtain a one-exchange and one-roasting molecular sieve dry powder; d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

The third aspect of the present disclosure provides a use of the catalytic cracking catalyst provided in the first aspect, or the catalytic cracking catalyst produced with the method provided in the second aspect in heavy oil processing, preferably in wax oil processing.

The fourth aspect of the present disclosure provides a method for processing wax oil comprising: in the presence of a catalyst, carrying out catalytic cracking on the wax oil to obtain the catalytic cracking products; wherein the catalytic cracking products comprise dry gas, liquefied gas, gasoline, diesel, heavy oil, and coke;

Wherein the catalyst is selected from the catalytic cracking catalyst provided in the first aspect or the catalytic cracking catalyst produced with the method provided in the second aspect.

The present disclosure has the following advantages over the prior art:
(1) The present disclosure provides a catalytic cracking catalyst having high activity, good stability, high crystallinity, strong wax oil conversion capability, desirable gasoline selectivity, high total liquid yield, excellent coke selectivity, and other characteristics by defining that the catalytic cracking catalyst comprises modified molecular sieve with specific modification treatment, and incorporating the synergistic effect of the binder and the matrix material, especially further adjusting the modification treatment process of the modified molecular sieve, and controlling the content ranges of the modified molecular sieve, the binder, and the matrix material;
(2) The present disclosure provides a modification treatment process for a modified molecular sieve by adding a precipitating agent (i.e., a first precipitating agent and a second precipitating agent) to the Y-type molecular sieve after the rare earth ion exchange and before the ammonium sulfate exchange, to form a metal oxide precipitation precursor with metal ions to avoid the generation of precipitate from the free rare earth ions and sulfate radical in the exchange system solution, on the surface of molecular sieve or in the supercage during the subsequent ammonium sulfate exchange and sodium reduction process, on the one hand, the process fulfills the purpose of reducing sulfate radical and improving crystallinity and stability of the modified molecular sieve, on the other hand, the process improves the utilization rate of rare earth ions.
(3) The method for preparing the catalytic cracking catalyst provided in the present disclosure has simple operations and simplified process flow, thus it is conducive to industrial production;

The use of the catalytic cracking catalyst of the present disclosure for processing wax oil can effectively increase the conversion rate of wax oil, improve the total liquid yield, and avoid the problems of converting the high content sulfate radical of the modified molecular sieve into sulfide and corrosion of equipment resulting from the sulfide.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

Unless otherwise specified in the present disclosure, the expressions “first”, “second”, and “third” do not indicate any precedence order or impose limitations on each material or step, the expressions are only used for distinguishing the different materials or steps. For example, the expressions “first”, “second”, and “third” in the terms “first water washing”, “second water washing”, and “third water washing” merely serve to distinguish the water washing steps; similarly, the expressions “first” and “second” of the terms “first ammonium sulfate exchange” and “second ammonium sulfate exchange” merely indicate that they are not the same ammonium sulfate exchange.

In the first aspect, the present disclosure provides a catalytic cracking catalyst comprising a modified molecular sieve, a binder, and a matrix material, wherein the modified molecular sieve is prepared by performing modification treatment to a Y-type molecular sieve;
wherein the modification treatment process comprises the following steps: a. performing rare earth ion exchange on the Y-type molecular sieve to obtain a rare earth ion exchange slurry; b. adding a first precipitating agent to perform a first precipitation on a part of rare earth ions in the rare earth ion exchange slurry to obtain a first precipitation slurry; c. subjecting the first precipitation slurry to a filtering, a first ammonium sulfate exchange, a first water washing, and a first roasting sequentially to obtain a one-exchange and one-roasting molecular sieve dry powder; d. adding a second precipitating agent to perform a second precipitation on a part of rare earth ions in the one-exchange and one-roasting molecular sieve dry powder, then performing a second ammonium sulfate exchange, a second water washing, and an optional second roasting sequentially to prepare the modified molecular sieve.

The present inventors have discovered in research that: firstly, ammonium sulfate which is cheap, harmless, and recyclable in industry is used as an exchanger, after rare earth ion exchange and before ammonium sulfate exchange, the precipitating agents (e.g., ammonium oxalate, ammonium carbonate, and aqueous ammonia) are added, the precipitating agents preferentially generate precipitation precursors of rare earth oxides by reacting with the rare earth ions, it avoids the generation of precipitate from the free rare earth ions and sulfate radical in the exchange system solution, on the surface of molecular sieve or in the supercage during the subsequent ammonium sulfate exchange and sodium reduction process, the process fulfills the purpose of reducing sulfate radical and improving crystallinity and stability of the modified molecular sieve, and improves utilization rate of the rare earth ions. Because the Y-type molecular sieve is a main activity ingredient of the catalytic cracking catalyst, the properties of the Y-type molecular sieve determine the properties of the catalytic cracking catalyst, the present disclosure reduces the content of sulfate radical in the Y-type molecular sieve through technical innovation, improves crystallinity and stability of the Y-type molecular sieve, when the Y-type molecular sieve is used as the activity ingredient of the catalyst, it correspondingly improves the cracking activity and the hydrothermal stability of the catalyst.

Moreover, the cracking activity and the hydrothermal stability of the catalytic cracking catalyst are further improved by further regulating and controlling the content ranges of modified molecular sieve, binder, and matrix material in the catalytic cracking catalyst, thereby improving the conversion rate of wax oil and the total liquid yield.

In some embodiments of the present disclosure, preferably, the modified molecular sieve is contained in an amount of 15-50 wt %, the binder is contained in an amount of 5-38 wt %, and the matrix material is contained in an amount of 35-80 wt % in the catalytic cracking catalyst on a dry basis; further preferably, the modified molecular sieve is contained in an amount of 25-45 wt %, the binder is contained in an amount of 8-35 wt %, and the matrix material is contained in an amount of 35-60 wt % in the catalytic cracking catalyst on a dry basis. The use of preferable conditions is more conducive to improving the cracking activity and hydrothermal stability of the catalytic cracking catalyst.

Unless otherwise specified in the present disclosure, the sum of the contents of the modified molecular sieve, binder, and matrix material is less than or equal to 100 wt %, preferably 100 wt %.

In a specific embodiment of the present disclosure, the catalytic cracking catalyst is composed of a modified molecular sieve, a binder, and a matrix material; wherein the content of the modified molecular sieve in the catalytic cracking catalyst on a dry basis is 15-50 wt %, preferably 25-45 wt %; the content of the binder is 5-38 wt %, preferably 8-35 wt %; the content of the matrix material is 35-80 wt %, preferably 35-60 wt %.

In the present disclosure, the modification treatment process of the modified molecular device has a wide selection range as long as the SO₄²⁻ content in the modified molecular device is less than or equal to 1 wt %. Preferably, the modification treatment process comprises the following steps:
a. performing rare earth ion exchange on the Y-type molecular sieve to obtain a rare earth ion exchange slurry;
b. adding a first precipitating agent to perform a first precipitation on a part of rare earth ions in the rare earth ion exchange slurry to obtain a first precipitation slurry;
c. subjecting the first precipitation slurry to a filtering, a first ammonium sulfate exchange, a first water washing, and a first roasting sequentially to obtain a one-exchange and one-roasting molecular sieve dry powder;
d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

In the present disclosure, there is a wide selection range for the kind of the Y-type molecular sieve. Preferably, the Y-type molecular sieve has a silica/alumina ratio within the range of 2-100, e.g. 2, 5, 10, 15, 20, 30, 40, 50, 80, 100, and a random value within the range consisting of any two numerical values, preferably within the range of 2-50. Wherein the silica/alumina ratio refers to the molar ratio of silicon oxide to aluminum oxide, and the silica/alumina ratio parameter is measured by X-Ray Fluorescence (XRF) or Inductively Coupled Plasma (ICP).

In some embodiments of the present disclosure, preferably, the Y-type molecular sieve is at least one selected from the group consisting of NaY molecular sieve, NaHY molecular sieve, NaUSY molecular sieve, NaREHY molecular sieve, and NaREUSY molecular sieve, more preferably selected from NaY molecular sieve and/or NaHY molecular sieve, further preferably selected from NaY molecular sieve.

In some embodiments of the present disclosure, preferably, in step-a, the conditions of the rare earth ion exchange comprise: a temperature of 25-180 °C, more preferably 50-80 °C; a pH of 2.8-6.5, more preferably 3.5-4.5; a time of 0.3-3.5 h, more preferably 0.5-1.5 h.

In some embodiments of the present disclosure, the rare earth ion exchange process preferably comprises: mixing the Y-type molecular sieve with water and then adding a soluble rare earth salt to perform the rare earth ion exchange.

In some embodiments of the present disclosure, the weight ratio of the Y-type molecular sieve to water is preferably 1:(1.5-30), e.g., 1:1.5, 1:2, 1:3, 1:4, 1:5, 1:10, 1:20, 1:30, and a random value within the range consisting of any two numerical values, more preferably 1:(2-5).

In some embodiments of the present disclosure, the soluble rare earth salt calculated in terms of RE₂O₃ is preferably contained in the Y-type molecular sieve on a dry basis in an amount of 1-20 wt %, for example, 1 wt %, 4 wt %, 6 wt %, 8 wt %, 10 wt %, 12 wt %, 14 wt %, 16 wt %, 20 wt %, and a random value within the range consisting of any two numerical values, more preferably 6-16 wt %. The use of preferable conditions is more conducive to eliminating the influence of sulfate radicals on the properties of the modified molecular sieve and improving the crystallinity and the catalytic cracking performance of the modified molecular sieve.

In the present disclosure, during the rare earth ion exchange process, the rare earth ions in the soluble rare earth salt are completely attached to the surface and inner pores and channels of the Y-type molecular sieve. Therefore, the weight ratio of the Y-type molecular sieve on a dry basis to the soluble rare earth salt calculated in terms of RE₂O₃ is 100:(1-20), preferably 100:(6-16).

Unless otherwise specified in the present disclosure, the term “soluble” means that the compound can be easily dissolved in water or readily dissolved in water with the aid of an auxiliary agent.

In some embodiments of the present disclosure, the soluble rare earth salt is preferably selected from chlorate and/or nitrate containing at least one of the rare earth elements. Wherein the rare earth elements include but are not limited to lanthanum, cerium, yttrium, etc., and the soluble rare earth salts include but are not limited to lanthanum chloride, lanthanum nitrate, cerium chloride, cerium nitrate, yttrium chloride, yttrium nitrate, etc.

In some embodiments of the present disclosure, preferably in step-b, the used amount of the first precipitating agent satisfies the molar ratio of the rare earth ions with a content of 1-4 wt % in the Y-type molecular sieve via the first precipitation, more preferably, the used amount of the first precipitating agent satisfies the molar ratio of the rare earth ions with a content of 1.5-2.5 wt % in the Y-type molecular sieve via the first precipitation. The use of preferable conditions is more conducive to eliminating the influence of sulfate radicals on the properties of the modified molecular sieve and improving the crystallinity and the catalytic cracking performance of the modified molecular sieve.

In the present disclosure, there is a wide range of choices for the kind of the first precipitating agent as long as the rare earth ions are prepared into a rare earth oxide precipitation precursor. Preferably, the first precipitating agent is at least one selected from the group consisting of ammonium oxalate, ammonium carbonate, ammonium bicarbonate, aqueous ammonia, urea, and ammonium acetate, more preferably at least one selected from the group consisting of ammonium oxalate, ammonium carbonate, ammonium bicarbonate, and aqueous ammonia.

In some embodiments of the present disclosure, preferably, the conditions of the first precipitation comprise a temperature of 25-180 °C, more preferably 50-80 °C; a time of 0.1-5 h, more preferably 0.1-2 h.

In the present disclosure, the first ammonium sulfate exchange serves to further exchange Na⁺ ions in the Y-type molecular sieve. Preferably, in step-c, the first ammonium sulfate exchange process comprises: exchanging the filtered product with a first aqueous ammonium sulfate solution.

In some embodiments of the present disclosure, preferably, the weight ratio of the first aqueous ammonium sulfate solution calculated in terms of ammonium sulfate to the Y-type molecular sieve is (5-50):100, e.g., 5:100, 10:100, 15:100, 20:100, 25:100, 30:100, 40:100, 50:100, and a random value within the range consisting of any two numerical values, more preferably (10-25):100.

In some embodiments of the present disclosure, preferably, the concentration of ammonium sulfate in the first aqueous ammonium sulfate solution is within the range of 20-400 g/L, for example, 20 g/L, 50 g/L, 80 g/L, 120 g/L, 150 g/L, 200 g/L, 250 g/L, 300 g/L, 400 g/L, and a random value within the range consisting of any two numerical values, more preferably 120-250 g/L.

In some embodiments of the present disclosure, preferably, the conditions of the first ammonium sulfate exchange comprise a temperature of 15-150 °C, more preferably 50-80 °C; a time of 0.1-5 h, more preferably 0.5-2 h.

In some embodiments of the present disclosure, preferably, in the first water washing, the used amount of water is 1-8 times the weight of the Y-type molecular sieve, e.g., 1 time, 2 times, 3 times, 4 times, 5 times, 8 times, and a random value within the range consisting of any two numerical values, more preferably 2-5 times of the weight of the Y-type molecular sieve.

In some embodiments of the present disclosure, preferably, the conditions of the first roasting comprise an atmosphere of 100% water vapor; a temperature of 400-700 °C, more preferably 500-650 °C; a time of 0.1-5 h, more preferably 0.5-3 h.

In some embodiments of the present disclosure, preferably in step-d, the used amount of the second precipitating agent satisfies the molar ratio of the rare earth ions with content of 0.5-3 wt % in the one-exchange and one-roasting molecular sieve dry powder via the second precipitation, further preferably, the used amount of the second precipitating agent satisfies the molar ratio of the rare earth ions with content of 1-2 wt % in the one-exchange and one-roasting molecular sieve dry powder via the second precipitation. The use of preferable conditions is more conducive to eliminating the influence of sulfate radicals on the properties of the modified molecular sieve and improving the crystallinity and the catalytic cracking performance of the modified molecular sieve.

In some embodiments of the present disclosure, preferably, the second precipitating agent is at least one selected from the group consisting of ammonium oxalate, ammonium carbonate, ammonium bicarbonate, aqueous ammonia, urea, and ammonium acetate, more preferably at least one selected from the group consisting of ammonium oxalate, ammonium carbonate, ammonium bicarbonate, and aqueous ammonia.

In some embodiments of the present disclosure, preferably, the conditions of the second precipitation comprise a temperature of 15-40 °C, more preferably 20-30 °C; a time of 0.1-5 h, more preferably 0.1-2 h.

In some embodiments of the present disclosure, preferably in step-d, the second ammonium sulfate exchange process comprises: exchanging the second precipitation product with a second aqueous ammonium sulfate solution.

In some embodiments of the present disclosure, the weight ratio of the second aqueous ammonium sulfate solution calculated in terms of ammonium sulfate to the one-exchange and one-roasting molecular sieve dry powder is preferably (5-50):100, e.g., 5:100, 10:100, 15:100, 20:100, 25:100, 30:100, 40:100, 50:100, and a random value within the range consisting of any two numerical values, more preferably (10-25):100.

In some embodiments of the present disclosure, the concentration of ammonium sulfate in the second aqueous ammonium sulfate solution is preferably within the range of 20-400 g/L, for example, 20 g/L, 50 g/L, 80 g/L, 120 g/L, 150 g/L, 200 g/L, 250 g/L, 300 g/L, 400 g/L, and a random value within the range consisting of any two numerical values, more preferably within the range of 120-250 g/L.

In some embodiments of the present disclosure, preferably, the conditions of the second ammonium sulfate exchange comprise a temperature of 20-85 °C, more preferably 50-80 °C; a time of 0.1-5 h, more preferably 0.1-2 h.

In some embodiments of the present disclosure, preferably, in the second water washing, the used amount of water is 1-8 times the weight of the one-exchange and one-roasting molecular sieve dry powder, for example, 1 time, 2 times, 3 times, 4 times, 5 times, 8 times, and a random value within the range consisting of any two numerical values, more preferably the used amount of water is 2-5 times of the weight of the one-exchange and one-roasting molecular sieve dry powder.

In some embodiments of the present disclosure, the conditions of the second roasting preferably comprise an atmosphere of 20-100 vol % water vapor; a temperature of 400-700 °C, more preferably 450-650 °C; a time of 0.1-10 h, more preferably 0.5-5 h.

In some embodiments of the present disclosure, it is preferred that before the second precipitation, blending the one-exchange and one-roasting molecular sieve dry powder with water; further preferably, the weight ratio of the one-exchange and one-roasting molecular sieve dry powder to water is within the range of 1:(1.5-30), e.g., 1:1.5, 1:2, 1:3, 1:4, 1:5, 1:10, 1:20, 1:30, and a random value within the range consisting of any two numerical values, more preferably 1:(2-5).

In some embodiments of the present disclosure, the binder is preferably at least one selected from the group consisting of an aluminum sol, an acidified pseudo-boehmite, an acidic silica sol, and a phospho-alumina sol, more preferably, the binder is at least one selected from the group consisting of an aluminum sol, an acidified pseudo-boehmite, and an acidic silica sol.

In some embodiments of the present disclosure, the matrix material is preferably at least one selected from the group consisting of kaoline, halloysite, porous stone, diatomaceous earth, sepiolite, macroporous alumina, boehmite, and a macro-porous silica-alumina material.

In the present disclosure, the modified molecular sieve has a low Na⁺ content, a high RE³⁺ content, and a high crystallinity, in addition to a low SO₄²⁻ content.

In some embodiments of the present disclosure, preferably, the modified molecular sieve has a SO₄²⁻ content less than or equal to 1 wt %, for example, 0.01 wt %, 0.05 wt %, 0.1 wt %, 0.2 wt %, 0.3 wt %, 0.45 wt %, 0.5 wt %, 1 wt %, and a random value within the range consisting of any two numerical values, more preferably less than or equal to 0.5 wt %, further preferably within the range of 0.01-0.45 wt %.

In some embodiments of the present disclosure, preferably, the modified molecular sieve has a Na⁺ content calculated in terms of Na₂O less than or equal to 1.2 wt %, for example, 0.01 wt %, 0.1 wt %, 0.3 wt %, 0.5 wt %, 0.6 wt %, 0.8 wt %, 0.9 wt %, 1 wt %, 1.2 wt %, and a random value within the range consisting of any two numerical values, more preferably less than or equal to 1 wt %.

In some embodiments of the present disclosure, the modified molecular sieve preferably has a RE³⁺ content calculated in terms of RE₂O₃ more than or equal to 5 wt %, e.g., 5 wt %, 6 wt %, 8 wt %, 10 wt %, 12 wt %, 15 wt %, 16 wt %, and a random value within the range consisting of any two numerical values, more preferably within the range of 6-16 wt %.

In some embodiments of the present disclosure, the modified molecular sieve preferably has a C/C₀ ratio more than or equal to 55, such as 55, 60, 65, 70, and a random value within the range consisting of any two numerical values, more preferably within the range of 55-70.

In some embodiments of the present disclosure, preferably, the catalytic cracking catalyst has a Na⁺ content calculated in terms of Na₂O less than or equal to 0.2 wt %, for example, 0.05 wt %, 0.08 wt %, 0.1 wt %, 0.15 wt %, 0.18 wt %, 0.2 wt %, and a random value within the range consisting of any two numerical values, more preferably within the range of 0.05-0.2 wt %.

Unless otherwise specified in the present disclosure, the SO₄²⁻ content, Na₂O content, and RE₂O₃ content are measured by the XRF method; the C/C₀ ratio is measured by the X-ray diffraction method.

In the second aspect, the present disclosure provides a method for preparing a catalytic cracking catalyst comprising the following steps:
(1) mixing a modified molecular sieve, a binder, a matrix material, and water to obtain a slurry;
(2) subjecting the slurry to homogenizing, molding, and a third roasting sequentially to obtain a catalyst precursor, performing a sodium reduction treatment on the catalyst precursor to prepare the catalytic cracking catalyst;
wherein the modified molecular sieve is prepared by performing modification treatment to a Y-type molecular sieve, and the modification treatment process comprises the following steps: a. performing rare earth ion exchange on the Y-type molecular sieve to obtain a rare earth ion exchange slurry; b. adding a first precipitating agent to perform a first precipitation on a part of rare earth ions in the rare earth ion exchange slurry to obtain a first precipitation slurry; c. subjecting the first precipitation slurry to a filtering, a first ammonium sulfate exchange, a first water washing, and a first roasting sequentially to obtain a one-exchange and one-roasting molecular sieve dry powder; d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

In the present disclosure, the conditions for the mixing in step (1) may be selected from a wide range as long as the modified molecular sieve, the binder, the matrix material, and the water are uniformly mixed. Preferably, the mixing conditions comprise a temperature of 15-70 °C, more preferably 25-60 °C; and a time of 0.1-5 h, more preferably 0.1-3 h.

In some embodiments of the present disclosure, preferably in step (1), the weight ratio of the modified molecular sieve, the binder, and the matrix material is (15-50):(5-38):(35-80), more preferably (25-45):(8-35):(35-60). In the present disclosure, the types of modified molecular sieve, binder, and matrix material are defined as above, and the content will not be repeatedly described herein.

In some embodiments of the present disclosure, preferably, the slurry has a solid content within the range of 25-50 wt %, e.g., 25 wt %, 30 wt %, 35 wt %, 40 wt %, 45 wt %, 50 wt %, and a random value within the range consisting of any two numerical values, more preferably within the range of 30-50 wt %.

In the present disclosure, the slurry particles are refined by homogenization such that the slurry is uniformly blended. Preferably, the homogenization is performed such that the average particle size of the particles in the slurry is less than or equal to 4 μm, for example, 0.5 μm, 1 μm, 1.5 μm, 2 μm, 2.5 μm, 3 μm, 4 μm, and a random value within the range consisting of any two numerical values, more preferably within the range of 0.5-3 μm.

In the present disclosure, there is a wide range of choices for the kind of molding. Preferably, the molding is selected from spray molding.

In some embodiments of the present disclosure, preferably in step (2), the conditions of the third roasting comprise a temperature of 400-550 °C, more preferably 450-500 °C; a time of 0.1-5 h, more preferably 0.1-2 h.

In some embodiments of the present disclosure, the sodium reduction treatment process preferably comprises: subjecting the ammonium salt and the slurry containing the catalyst precursor to mixing, filtering, the third water washing, and drying sequentially to prepare the catalytic cracking catalyst.

In the present disclosure, the slurry containing the catalyst precursor refers to an aqueous solution containing the catalyst precursor. Preferably, the solid content of the slurry containing the catalyst precursor is within the range of 10-40 wt %, e.g. 10 wt %, 20 wt %, 25 wt %, 30 wt %, 32 wt %, 35 wt %, 38 wt %, 40 wt %, and a random value within the range consisting of any two numerical values, more preferably within the range of 30-38 wt %.

In the present disclosure, the ammonium salt includes but is not limited to, ammonium chloride and/or ammonium nitrate, preferably ammonium chloride.

In some embodiments of the present disclosure, the weight ratio of the ammonium salt to the slurry containing the catalyst precursor calculated in terms of the catalyst precursor is preferably (1-10):100, e.g., 1:100, 3:100, 4:100, 5:100, 6:100, 7:100, 8:100, 10:100, and a random value within the range consisting of any two numerical values, more preferably (3-8):100.

In some embodiments of the present disclosure, preferably in the third water washing, the used amount of water is 1-8 times, for example, 1 time, 1.5 times, 2 times, 2.5 times, 3 times, 4 times, 5 times, 8 times, and a random value within the range consisting of any two numerical values, more preferably 1.5-3 times of the weight of the catalytic cracking catalyst.

In the present disclosure, the drying condition in the sodium reduction treatment is limited in a wide range as long as the residual water in the third water-washed product is removed.

In some embodiments of the present disclosure, the modification treatment process preferably comprises the following steps:
a. performing rare earth ion exchange on the Y-type molecular sieve to obtain a rare earth ion exchange slurry;
b. adding a first precipitating agent to perform a first precipitation on a part of rare earth ions in the rare earth ion exchange slurry to obtain a first precipitation slurry;
c. subjecting the first precipitation slurry to a filtering, a first ammonium sulfate exchange, a first water washing, and a first roasting sequentially to obtain a one-exchange and one-roasting molecular sieve dry powder;
d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

In the present disclosure, there is a wide selection range for the kind of the Y-type molecular sieve. Preferably, the Y-type molecular sieve has a silica/alumina ratio within the range of 2-100, e.g. 2, 5, 10, 15, 20, 30, 40, 50, 80, 100, and a random value within the range consisting of any two numerical values, more preferably within the range of 2-50. Wherein the silica/alumina ratio refers to the molar ratio of silicon oxide to aluminum oxide, and the silica/alumina ratio parameter is measured by X-Ray Fluorescence (XRF) or Inductively Coupled Plasma (ICP).

In some embodiments of the present disclosure, the Y-type molecular sieve is preferably at least one selected from the group consisting of NaY molecular sieve, NaHY molecular sieve, NaUSY molecular sieve, NaREHY molecular sieve, and NaREUSY molecular sieve, more preferably selected from NaY molecular sieve and/or NaHY molecular sieve, further preferably selected from NaY molecular sieve.

In some embodiments of the present disclosure, preferably in step-a, the conditions of the rare earth ion exchange comprise a temperature of 25-180 °C, more preferably 50-80 °C; a pH of 2.8-6.5, more preferably 3.5-4.5; a time of 0.3-3.5 h, more preferably 0.5-1.5 h.

In some embodiments of the present disclosure, the rare earth ion exchange process preferably comprises: mixing the Y-type molecular sieve with water and then adding a soluble rare earth salt to perform the rare earth ion exchange.

In some embodiments of the present disclosure, the weight ratio of the Y-type molecular sieve to water is preferably 1:(1.5-30), e.g., 1:1.5, 1:2, 1:3, 1:4, 1:5, 1:10, 1:20, 1:30, and a random value within the range consisting of any two numerical values, more preferably 1:(2-5).

In some embodiments of the present disclosure, the soluble rare earth salt calculated in terms of RE₂O₃ is preferably contained in the Y-type molecular sieve on a dry basis in an amount of 1-20 wt %, for example, 1 wt %, 4 wt %, 6 wt %, 8 wt %, 10 wt %, 12 wt %, 14 wt %, 16 wt %, 20 wt %, and a random value within the range consisting of any two numerical values, more preferably 6-16 wt %. The use of preferable conditions is more conducive to eliminating the influence of sulfate radicals on the properties of the modified molecular sieve and improving the crystallinity and the catalytic cracking performance of the modified molecular sieve.

In the present disclosure, during the rare earth ion exchange process, the rare earth ions in the soluble rare earth salt are completely attached to the surface and inner pores and channels of the Y-type molecular sieve. Therefore, the weight ratio of the Y-type molecular sieve on a dry basis to the soluble rare earth calculated in terms of RE₂O₃ is 100:(1-20), preferably 100:(6-16).

Unless otherwise specified in the present disclosure, the term “soluble” means that the compound can be easily dissolved in water or readily dissolved in water with the aid of an auxiliary agent.

In some embodiments of the present disclosure, preferably, the soluble rare earth salt is selected from chlorate and/or nitrate containing at least one of the rare earth elements. Wherein the rare earth elements include but are not limited to lanthanum, cerium, yttrium, etc., and the soluble rare earth salts include but are not limited to lanthanum chloride, lanthanum nitrate, cerium chloride, cerium nitrate, yttrium chloride, yttrium nitrate, etc.

In some embodiments of the present disclosure, preferably in step-b, the used amount of the first precipitating agent satisfies the molar ratio of the rare earth ions with a content of 1-4 wt % in the Y-type molecular sieve via the first precipitation, more preferably, the used amount of the first precipitating agent satisfies the molar ratio of the rare earth ions with a content of 1.5-2.5 wt % in the Y-type molecular sieve via the first precipitation. The use of preferable conditions is more conducive to eliminating the influence of sulfate radicals on the properties of the modified molecular sieve and improving the crystallinity and the catalytic cracking performance of the modified molecular sieve.

In the present disclosure, there is a wide range of choices for the kind of the first precipitating agent as long as the rare earth ions are prepared into a rare earth oxide precipitation precursor. Preferably, the first precipitating agent is at least one selected from the group consisting of ammonium oxalate, ammonium carbonate, ammonium bicarbonate, aqueous ammonia, urea, and ammonium acetate, more preferably at least one selected from the group consisting of ammonium oxalate, ammonium carbonate, ammonium bicarbonate, and aqueous ammonia.

In some embodiments of the present disclosure, the conditions of the first precipitation preferably comprise: a temperature of 25-180 °C, more preferably 50-80 °C; a time of 0.1-5 h, more preferably 0.1-2 h.

In the present disclosure, the first ammonium sulfate exchange serves to further exchange Na⁺ ions in the Y-type molecular sieve. Preferably, the first ammonium sulfate exchange process in step-c comprises: exchanging the filtered product with a first aqueous ammonium sulfate solution.

In some embodiments of the present disclosure, the weight ratio of the first aqueous ammonium sulfate solution calculated in terms of ammonium sulfate to the Y-type molecular sieve is preferably (5-50):100, e.g., 5:100, 10:100, 15:100, 20:100, 25:100, 30:100, 40:100, 50:100, and a random value within the range consisting of any two numerical values, more preferably (10-25):100.

In some embodiments of the present disclosure, the concentration of ammonium sulfate in the first aqueous ammonium sulfate solution is preferably within the range of 20-400 g/L, for example, 20 g/L, 50 g/L, 80 g/L, 120 g/L, 150 g/L, 200 g/L, 250 g/L, 300 g/L, 400 g/L, and a random value within the range consisting of any two numerical values, more preferably 120-250 g/L.

In some embodiments of the present disclosure, the conditions of the first ammonium sulfate exchange preferably comprise a temperature of 15-150 °C, more preferably 50-80 °C; a time of 0.1-5 h, more preferably 0.5-2 h.

In some embodiments of the present disclosure, preferably in the first water washing, the used amount of water is 1-8 times the weight of the Y-type molecular sieve, e.g., 1 time, 2 times, 3 times, 4 times, 5 times, 8 times, and a random value within the range consisting of any two numerical values, more preferably 2-5 times of the weight of the Y-type molecular sieve.

In some embodiments of the present disclosure, the conditions of the first roasting preferably comprise an atmosphere of 100% water vapor; a temperature of 400-700 °C, more preferably 500-650 °C; a time of 0.1-5 h, more preferably 0.5-3 h.

In some embodiments of the present disclosure, preferably in step-d, the used amount of the second precipitating agent satisfies the molar ratio of the rare earth ions with content of 0.5-3 wt % in the one-exchange and one-roasting molecular sieve dry powder via the second precipitation, further preferably, the used amount of the second precipitating agent satisfies the molar ratio of the rare earth ions with content of 1-2 wt % in the one-exchange and one-roasting molecular sieve dry powder via the second precipitation. The use of preferable conditions is more conducive to eliminating the influence of sulfate radicals on the properties of the modified molecular sieve and improving the crystallinity and the catalytic cracking performance of the modified molecular sieve.

In some embodiments of the present disclosure, preferably, the second precipitating agent is at least one selected from the group consisting of ammonium oxalate, ammonium carbonate, ammonium bicarbonate, aqueous ammonia, urea, and ammonium acetate, more preferably at least one selected from the group consisting of ammonium oxalate, ammonium carbonate, ammonium bicarbonate, and aqueous ammonia.

In some embodiments of the present disclosure, the conditions of the second precipitation preferably comprise a temperature of 15-40 °C, more preferably 20-30 °C; a time of 0.1-5 h, more preferably 0.1-2 h.

In some embodiments of the present disclosure, preferably in step-d, the second ammonium sulfate exchange process comprises: exchanging the second precipitation product with a second aqueous ammonium sulfate solution.

In some embodiments of the present disclosure, the weight ratio of the second aqueous ammonium sulfate solution calculated in terms of ammonium sulfate to the one-exchange and one-roasting molecular sieve dry powder is preferably (5-50):100, e.g., 5:100, 10:100, 15:100, 20:100, 25:100, 30:100, 40:100, 50:100, and a random value within the range consisting of any two numerical values, more preferably (10-25):100.

In some embodiments of the present disclosure, the concentration of ammonium sulfate in the second aqueous ammonium sulfate solution is preferably within the range of 20-400 g/L, for example, 20 g/L, 50 g/L, 80 g/L, 120 g/L, 150 g/L, 200 g/L, 250 g/L, 300 g/L, 400 g/L, and a random value within the range consisting of any two numerical values, more preferably within the range of 120-250 g/L.

In some embodiments of the present disclosure, the conditions of the second ammonium sulfate exchange preferably comprise: a temperature of 20-85 °C, more preferably 50-80 °C; a time of 0.1-5 h, more preferably 0.1-2 h.

In some embodiments of the present disclosure, preferably in the second water washing, the used amount of water is 1-8 times the weight of the one-exchange and one-roasting molecular sieve dry powder, for example, 1 time, 2 times, 3 times, 4 times, 5 times, 8 times, and a random value within the range consisting of any two numerical values, more preferably the used amount of water is 2-5 times of the weight of the one-exchange and one-roasting molecular sieve dry powder.

In some embodiments of the present disclosure, the conditions of the second roasting preferably comprise an atmosphere of 20-100 vol % water vapor; a temperature of 400-700 °C, more preferably 450-650 °C; a time of 0.1-10 h, more preferably 0.5-5 h.

In some embodiments of the present disclosure, preferably, before the second precipitation, blending the one-exchange and one-roasting molecular sieve dry powder with water; further preferably, the weight ratio of the one-exchange and one-roasting molecular sieve dry powder to water is within the range of 1:(1.5-30), e.g., 1:1.5, 1:2, 1:3, 1:4, 1:5, 1:10, 1:20, 1:30, and a random value within the range consisting of any two numerical values, more preferably 1:(2-5).

In the present disclosure, the modified molecular sieve prepared by using the modification treatment process has characteristics such as a low SO₄²⁻ content, a low Na⁺ content, a high RE³⁺ content, and a high crystallinity.

In some embodiments of the present disclosure, the modified molecular sieve preferably has a SO₄²⁻ content less than or equal to 1 wt %, for example, 0.01 wt %, 0.05 wt %, 0.1 wt %, 0.2 wt %, 0.3 wt %, 0.45 wt %, 0.5 wt %, 1 wt %, and a random value within the range consisting of any two numerical values, more preferably less than or equal to 0.5 wt %, further preferably within the range of 0.01-0.45 wt %.

In some embodiments of the present disclosure, the modified molecular sieve preferably has a Na⁺ content calculated in terms of Na₂O less than or equal to 1.2 wt %, for example, 0.01 wt %, 0.1 wt %, 0.3 wt %, 0.5 wt %, 0.6 wt %, 0.8 wt %, 0.9 wt %, 1 wt %, 1.2 wt %, and a random value within the range consisting of any two numerical values, more preferably less than or equal to 1 wt %.

In some embodiments of the present disclosure, the modified molecular sieve preferably has a RE³⁺ content calculated in terms of RE₂O₃ more than or equal to 5 wt %, e.g., 5 wt %, 6 wt %, 8 wt %, 10 wt %, 12 wt %, 15 wt %, 16 wt %, and a random value within the range consisting of any two numerical values, more preferably within the range of 6-16 wt %.

In some embodiments of the present disclosure, the modified molecular sieve preferably has a C/C₀ ratio more than or equal to 55, such as 55, 60, 65, 70, and a random value within the range consisting of any two numerical values, more preferably within the range of 55-70.

In the present disclosure, the catalytic cracking catalyst prepared with the method has a low Na⁺ content. Preferably, the catalytic cracking catalyst has a Na⁺ content calculated in terms of Na₂O less than or equal to 0.2 wt %, for example, 0.05 wt %, 0.08 wt %, 0.1 wt %, 0.15 wt %, 0.18 wt %, 0.2 wt %, and a random value within the range consisting of any two numerical values, more preferably within the range of 0.05-0.2 wt %.

The third aspect of the present disclosure provides a use of the catalytic cracking catalyst provided in the first aspect, or the catalytic cracking catalyst produced with the method provided in the second aspect in heavy oil processing, preferably in wax oil processing.

The fourth aspect of the present disclosure provides a method for processing wax oil comprising: in the presence of a catalyst, carrying out catalytic cracking on the wax oil to obtain the catalytic cracking products; wherein the catalytic cracking products comprise dry gas, liquefied gas, gasoline, diesel, heavy oil, and coke;

Wherein the catalyst is selected from the catalytic cracking catalyst provided in the first aspect or the catalytic cracking catalyst produced with the method provided in the second aspect.

In some embodiments of the present disclosure, the weight ratio of the catalyst to the wax oil is preferably (4-12):1, e.g., 4:1, 5:1, 6:1, 7:1, 8:1, 9:1, 10:1, 12:1, and a random value within the range consisting of any two numerical values, more preferably (6-9):1. The adoption of the preferred conditions is more beneficial to improving the conversion rate of wax oil and the total liquid yield. In the present disclosure, the total liquid yield refers to the sum of yields of liquefied gas, gasoline, and diesel.

In the present disclosure, the conditions of the catalytic cracking are not limited, and the conditions of the catalytic cracking depend not only on the reaction raw materials (the types and dosages of the wax oil and catalyst) but also on the various reaction apparatuses (fixed fluidized bed reactor, rising pipe reactor, etc.).

According to a particularly preferred embodiment of the present disclosure, a catalytic cracking catalyst, the catalytic cracking catalyst comprises a modified molecular sieve, a binder, and a matrix material, wherein the modified molecular sieve is prepared by performing modification treatment to a Y-type molecular sieve, and the SO₄²⁻ content in the modified molecular sieve is less than or equal to 0.5 wt %;

Wherein the catalytic cracking catalyst has a Na⁺ content calculated in terms of Na₂O less than or equal to 0.2 wt %;

Wherein the modified molecular sieve is contained in an amount of 25-45 wt %, the binder is contained in an amount of 8-35 wt %, and the matrix material is contained in an amount of 35-60 wt % in the catalytic cracking catalyst on a dry basis;

Wherein the modification treatment process comprises the following steps:
a. performing rare earth ion exchange on the Y-type molecular sieve to obtain a rare earth ion exchange slurry;
b. adding a first precipitating agent to perform a first precipitation on a part of rare earth ions in the rare earth ion exchange slurry to obtain a first precipitation slurry;
c. subjecting the first precipitation slurry to a filtering, a first ammonium sulfate exchange, a first water washing, and a first roasting sequentially to obtain a one-exchange and one-roasting molecular sieve dry powder;
d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

The present disclosure will be described in detail below with reference to examples.

NaY molecular sieves (with a silica/alumina ratio of 5.1 and crystallinity of 95%) were commercially available from Changting Catalysts, Co., Ltd.;

Each pseudo-boehmite (with a loss on ignition of 36.7%), kaolin (with a loss on ignition of 18.4%), halloysite (with a loss on ignition of 23.2%), porous stone (with a loss on ignition of 18.2%), diatomaceous earth (with a loss on ignition of 23.6%), sepiolite (with a loss on ignition of 25.3%), macro-porous alumina (with a loss on ignition of 16.8%), boehmite (with a loss on ignition of 14.5%), a macro-porous silica-alumina material (with a solid content of 15.4% and a pore volume of 1.15 mL/g); alumina sol containing 22.6 wt % of alumina; silica sol containing 30.5 wt % of silica was an industrially qualified product;

The SO₄²⁻ content, the Na₂O content and the RE₂O₃ content were measured by the XRF method;

The crystallinity (C/C₀) parameter was measured by X-ray diffraction method;

The micro-activity test (MAT) parameter was measured with the following process: the sample was pretreated under the conditions of 800 °C and 100% water vapor for different times; the reaction raw material was Dagang light diesel from Tianjin, the reaction temperature was 460 °C, the reaction time was 70s, the loading amount of catalyst was 5 g, the weight ratio of the catalyst to the oil was 3.2, and the total conversion rate was used as the micro-activity.

The physical properties of the modified molecular sieves prepared in Preparation Examples 1-11 (Z1-Z7 and DZ1-DZ4) were shown in Table 1.

### Preparation Example 1

a. 1,000 g (dry basis weight) of NaY molecular sieve was pulped with 5 L of deionized water, 0.537 L of LaCl₃ solution (La³⁺ ion was 0.98 mol) with a concentration of 298 g/L (calculated in terms of La₂O₃) was added to perform the rare earth ion exchange (the temperature was 80 °C, and the time was 0.5 h) to obtain a rare earth ion exchange slurry; wherein the content of LaCl₃ calculated in terms of La₂O₃ in the NaY molecular sieve on a dry basis was 16 wt %;
b. 32 g (0.225 mol) of ammonium oxalate monohydrate was added, such that 2.4 wt % of La³⁺ in the rare earth ion exchange slurry was subjected to a first precipitation (at 80 °C for 0.5 h) to obtain a first precipitation slurry;
c. The first precipitation slurry was filtered and drained, 0.833 L of aqueous ammonium sulfate solution with a concentration of 180 g/L was added, exchange was performed at 60 °C for 1 h, drained, 3 L of water was added for leaching, subsequently roasted at 500 °C in 100% water vapor atmosphere for 2 h to obtain one-exchange and one-roasting molecular sieve dry powder;
d. 1,000 g (dry basis weight) of the one-exchange and one-roasting molecular sieve dry powder was pulped with 5 L of deionized water, 25.6 g (0.18 mol) of ammonium oxalate monohydrate was then added, such that 2 wt % of La³⁺ in the one-exchange and one-roasting molecular sieve dry powder was subjected to second precipitation (at 25 °C for 0.5 h), 0.6 L of aqueous ammonium sulfate solution with a concentration of 250 g/L was added to carry out exchange at 80 °C for 1.5 h, the filtering and the draining were performed, 5 L of water was added for leaching, roasting was performed at 450 °C in 100% water vapor atmosphere for 2 h to prepare the modified molecular sieve Z1.

### Preparation Example 2

a. 1,000 g (dry basis weight) of NaY molecular sieve was pulped with 5 L of deionized water, 0.358 L of La(NO₃)₃ solution (La³⁺ ion was 0.615 mol) with a concentration of 280 g/L (calculated in terms of La₂O₃) was added to perform the rare earth ion exchange (the temperature was 50 °C, and the time was 1.5 h) to obtain a rare earth ion exchange slurry; wherein the content of La(NO₃)₃ calculated in terms of La₂O₃ in the NaY molecular sieve on a dry basis was 10 wt %;
b. 25.6 g (0.18 mol) of ammonium oxalate monohydrate was added, such that 2 wt % of La³⁺ in the rare earth ion exchange slurry was subjected to a first precipitation (at 50 °C for 0.5 h) to obtain a first precipitation slurry;
c. The first precipitation slurry was filtered and drained, 1.111 L of aqueous ammonium sulfate solution with a concentration of 180 g/L was added, exchange was performed at 80 °C for 1 h, drained, 3 L of water was added for leaching, subsequently roasted at 600 °C in 100% water vapor atmosphere for 2 h to obtain one-exchange and one-roasting molecular sieve dry powder;
d. 1,000 g (dry basis weight) of the one-exchange and one-roasting molecular sieve dry powder was pulped with 5 L of deionized water, 13 g (0.135 mol) of ammonium carbonate was then added, such that 1.5 wt % of La³⁺ in the one-exchange and one-roasting molecular sieve dry powder was subjected to second precipitation (at 25 °C for 0.5 h), 1.666 L of aqueous ammonium sulfate solution with a concentration of 120 g/L was added to carry out exchange at 50 °C for 1 h, the filtering, and the draining were performed, 2 L of water was added for leaching, roasting was performed at 500 °C in 80% water vapor atmosphere for 2.5 h to prepare the modified molecular sieve Z2.

### Preparation Example 3

a. 1,000 g (dry basis weight) of NaY molecular sieve was pulped with 5 L of deionized water, 0.407 L of YCl₃ solution (Y³⁺ ion was 0.513 mol) with a concentration of 246 g/L (calculated in terms of Y₂O₃) to perform the rare earth ion exchange (the temperature was 60 °C, and the time was 1 h) to obtain a rare earth ion exchange slurry; wherein the content of YCl₃ calculated in terms of Y₂O₃ in the NaY molecular sieve on a dry basis was 5.97 wt %;
b. 32 g (0.225 mol) of ammonium oxalate monohydrate was added, such that 1.7 wt % of Y³⁺ in the rare earth ion exchange slurry was subjected to a first precipitation (at 60 °C for 1.5 h) to obtain a first precipitation slurry;
c. The first precipitation slurry was filtered and drained, 1.398 L of aqueous ammonium sulfate solution with a concentration of 180 g/L was added, exchange was performed at 60 °C for 1.5 h, drained, 3 L of water was added for leaching, subsequently roasted at 650 °C in 100% water vapor atmosphere for 2 h to obtain one-exchange and one-roasting molecular sieve dry powder;
d. 1,000 g (dry basis weight) of the one-exchange and one-roasting molecular sieve dry powder was pulped with 5 L of deionized water, 22.6 g (0.16 mol) of ammonium oxalate monohydrate was then added, such that 1.2 wt % of Y³⁺ in the one-exchange and one-roasting molecular sieve dry powder was subjected to second precipitation (at 25 °C for 0.5 h), 1.389 L of aqueous ammonium sulfate solution with a concentration of 180 g/L was added to carry out exchange at 50 °C for 1 h, the filtering and the draining were performed, 3 L of water was added for leaching, roasting was performed at 650 °C in 60% water vapor atmosphere for 2 h to prepare the modified molecular sieve Z3.

### Preparation Example 4

a. 1,000 g (dry basis weight) of NaY molecular sieve was pulped with 5 L of deionized water, 0.43 L of mixed RECl₃ solution (the weight ratio of Ce₂O₃ to La₂O₃ was 6:4, and RE³⁺ ion was 0.9287 mol) with a concentration of 326 g/L (calculated in terms of RE₂O₃) was added to perform the rare earth ion exchange (the temperature was 60 °C, and the time was 1 h) to obtain a rare earth ion exchange slurry; wherein the content of RECl₃ calculated in terms of RE₂O₃ in the NaY molecular sieve on a dry basis was 14 wt %;
b. 25.6 g (0.18 mol) of ammonium oxalate monohydrate was added, 5 mL of industrial aqueous ammonia with a concentration of 28% was further added, such that 2.4 wt % of RE³⁺ in the rare earth ion exchange slurry was subjected to a first precipitation (at 60 °C for 0.5 h) to obtain a first precipitation slurry;
c. The first precipitation slurry was filtered and drained, 1.222 L of aqueous ammonium sulfate solution with a concentration of 180 g/L was added, exchange was performed at 100 °C for 0.5 h, drained, 5 L of water was added for leaching, subsequently roasted at 600 °C in 100% water vapor atmosphere for 2 h to obtain one-exchange and one-roasting molecular sieve dry powder;
d. 1,000 g (dry basis weight) of the one-exchange and one-roasting molecular sieve dry powder was pulped with 5 L of deionized water, 18 g (0.187 mol) of ammonium carbonate was then added, such that 1.8 wt % of RE³⁺ in the one-exchange and one-roasting molecular sieve dry powder was subjected to second precipitation (at 25 °C for 0.5 h), 1 L of aqueous ammonium sulfate solution with a concentration of 120 g/L was added to carry out the exchange at 25 °C for 1 h, the filtering, and the draining were performed, 4 L of water was added for leaching, roasting was performed at 550 °C in 20% water vapor atmosphere for 2 h to prepare the modified molecular sieve Z4.

### Preparation Example 5

The modified molecular sieve was prepared according to the method in Preparation Example 1, except that in step-a, 0.537 L of LaCl₃ solution with a concentration of 298 g/L (calculated in terms of La₂O₃) was replaced with 0.67 L of LaCl₃ solution with a concentration of 298 g/L (calculated in terms of La₂O₃), such that the content of LaCl₃ calculated in terms of La₂O₃ in the NaY molecular sieve on a dry basis was 20 wt %, the modified molecular sieve Z5 was prepared.

### Preparation Example 6

The modified molecular sieve was prepared according to the method in Preparation Example 1, except that in step-b, 32 g (0.225 mol) of ammonium oxalate monohydrate was replaced with 12.8 g (0.09 mol) of ammonium oxalate monohydrate, such that 1 wt % of La³⁺ in the rare earth ion exchange slurry was subjected to first precipitation (at 80 °C for 0.5 h), the modified molecular sieve Z6 was prepared.

### Preparation Example 7

The modified molecular sieve was prepared according to the method in Preparation Example 1, except that in step-d, 25.6 g (0.18 mol) of ammonium oxalate monohydrate was replaced with 6.4 g (0.045 mol) of ammonium oxalate monohydrate, such that 0.5 wt % of La³⁺ in the one-exchange and one-roasting molecular sieve dry powder was subjected to second precipitation (at 25 °C for 0.5 h); the modified molecular sieve Z7 was prepared.

### Preparation Example 8

The modified molecular sieve DZ1 was prepared according to the method disclosed in CN101088613A with an application number “200610087535.2”, namely,
1,000 g (dry basis weight) of NaY molecular sieve was pulped with 8 L of deionized water, 0.385 L of RECl₃ solution with a concentration of 312 g/L (calculated in terms of La₂O₃) was added, 240 g of aluminum sulfate was further added, exchange was performed at 90 °C for 1 h, 75 g of ammonium bicarbonate was subsequently, stirring was implemented at constant temperature for 0.25 h, the filtering was performed, 5 L of water was used for leaching, a filter cake was roasted at 600 °C in 100% water vapor atmosphere for 2 h to obtain one-exchange and one-roasting molecular sieve dry powder;
1,000 g of the one-exchange and one-roasting molecular sieve dry powder (dry basis weight) was pulped with 6 L of deionized water, 300 g of ammonium sulfate was added, exchange was carried out at 75 °C for 1 h, the filtering was performed, 6 L of water was used for leaching, a filter cake was dried, the modified molecular sieve DZ1 was prepared.

### Preparation Example 9

The modified molecular sieve was prepared according to the method in Preparation Example 1, except that in step-b, 32 g (0.225 mol) of ammonium oxalate monohydrate was not added, the modified molecular sieve DZ2 was prepared.

### Preparation Example 10

The modified molecular sieve was prepared according to the method in Preparation Example 2, except that in step-b, 25.6 g (0.18 mol) of ammonium oxalate monohydrate was not added, the modified molecular sieve DZ3 was prepared.

### Preparation Example 11

The modified molecular sieve was prepared according to the method in Preparation Example 4, except that in step-b, 25.6 g (0.18 mol) of ammonium oxalate monohydrate and 5 mL of industrial aqueous ammonia with a concentration of 28% were not added, and in step-d, 18 g (0.187 mol) of ammonium carbonate was not added, the modified molecular sieve DZ4 was prepared.

TABLE 1

| | Modified | SO₄²⁻ | Na₂O | RE₂O₃ | |
|---|---|---|---|---|---|
| | molecular | content, | content, | content, | |
| | sieve | wt % | wt % | wt % | C/C₀, % |
| Preparation | Z1 | 0.27 | 0.92 | 16.2 | 58 |
| Example 1 | | | | | |
| Preparation | Z2 | 0.41 | 0.98 | 10.4 | 62 |
| Example 2 | | | | | |
| Preparation | Z3 | 0.25 | 0.68 | 6.1 | 76 |
| Example 3 | | | | | |
| Preparation | Z4 | 0.32 | 0.82 | 14.3 | 59 |
| Example 4 | | | | | |
| Preparation | Z5 | 0.67 | 0.92 | 19.8 | 55 |
| Example 5 | | | | | |
| Preparation | Z6 | 0.82 | 1.1 | 15.6 | 57 |
| Example 6 | | | | | |
| Preparation | Z7 | 0.95 | 1.1 | 16.1 | 56 |
| Example 7 | | | | | |
| Preparation | DZ1 | 2.53 | 1.8 | 12.1 | 55 |
| Example 8 | | | | | |
| Preparation | DZ2 | 1.55 | 1.5 | 14.6 | 57 |
| Example 9 | | | | | |
| Preparation | DZ3 | 1.46 | 1.3 | 9.6 | 59 |
| Example 10 | | | | | |
| Preparation | DZ4 | 2.12 | 1.3 | 12.6 | 55 |
| Example 11 | | | | | |

As can be seen from the data in Table 1, compared with the modified molecular sieved prepared in Preparation Examples 8-11, the modified molecular sieves prepared with the modification treatment process provided by the present disclosure have a higher rare earth utilization rate, lower sulfate radical content, and higher crystallinity.

Compared with Preparation Example 5, Preparation Example 1 adopts a scheme of controlling that the content of soluble rare earth salt calculated in terms of RE₂O₃ in the NaY molecular sieve on a dry basis falls into the preferable scope, the prepared molecular sieve has the lower sulfate radical content and higher crystallinity.

Compared with Preparation Example 6, Preparation Example 1 adopts a scheme of controlling the dosage of the first precipitating agent such that the content of rare earth ions in the first precipitation falls into the preferable scope, the prepared molecular sieve has the lower sulfate radical content and higher crystallinity.

Compared with Preparation Example 7, Preparation Example 1 adopts a scheme of controlling the dosage of the second precipitating agent such that the content of precipitated rare earth ions falls into the preferable scope, the prepared molecular sieve has the lower sulfate radical content and higher crystallinity.

### Test Example 1

The modified molecular sieves (Z1-Z7 and DZ1-DZ4) prepared in Preparation Examples 1-11 were subjected to a hydrothermal stability test.

The test conditions comprise: 100 g (dry basis) of modified molecular sieve (Z1-Z7 and DZ1-DZ4) were tableted respectively, crushed into 20-40 meshes of particles, aged at 800 °C and 100% of water vapor in a fixed bed hydrothermal treatment device for 10 h, the micro-activity (MA) was then measured on a catalytic cracking automatic micro-activity evaluation instrument, the test results were listed in Table 2.

TABLE 2

| | Modified molecular sieve | MA, wt % |
|---|---|---|
| Preparation | Z1 | 72 |
| Example 1 | | |
| Preparation | Z2 | 65 |
| Example 2 | | |
| Preparation | Z3 | 73 |
| Example 3 | | |
| Preparation | Z4 | 70 |
| Example 4 | | |
| Preparation | Z5 | 71 |
| Example 5 | | |
| Preparation | Z6 | 68 |
| Example 6 | | |
| Preparation | Z7 | 66 |
| Example 7 | | |
| Preparation | DZ1 | 60 |
| Example 8 | | |
| Preparation | DZ2 | 61 |
| Example 9 | | |
| Preparation | DZ3 | 58 |
| Example 10 | | |
| Preparation | DZ4 | 61 |
| Example 11 | | |

As illustrated by the data in Table 2, compared with the modified molecular sieves produced in Preparation Examples 8-11, the modified molecular sieves produced in Preparation Examples 1-7 have significantly higher micro-activity (i.e., higher MA value) after aging under the condition of 800 °C in 100% water vapor for 10 h. Therefore, the modified molecular sieves prepared with the modification treatment process provided by the present disclosure have better hydrothermal stability and cracking activity.

### Example 1

(1) The modified molecular sieve Z1, aluminum sol, kaolin, and water were mixed at 25 °C for 1 h to obtain a slurry with a solid content of 50 wt %; wherein the weight ratio of the modified molecular sieve Z1, the alumina sol, and the kaolin was 32:8:60;
(2) The slurry was subjected to homogenizing, spray molding, and roasting at 450 °C for 30 min sequentially to obtain a catalyst precursor, which was mixed with water to obtain a slurry containing catalyst precursor with a solid content of 20 wt %, the slurry was then mixed with ammonium chloride, filtered, washed with 5 times of water, and dried at 100 °C for 12 h to prepare a catalytic cracking catalyst C1;
Wherein the weight ratio of the ammonium chloride to the slurry containing the catalyst precursor calculated in terms of the catalyst precursor was 5:100.

Wherein in the catalytic cracking catalyst C1, the Na⁺ content calculated in terms of Na₂O was 0.15 wt %; in the catalytic cracking catalyst C1 on a dry basis, the modified molecular sieve Z1 content was 32 wt %, the binder content was 8 wt %, and matrix material content was 60 wt %.

### Example 2

(1) The modified molecular sieve Z2, acidified pseudo-boehmite, aluminum sol, kaolin, and water were mixed at 25 °C for 1 h to obtain a slurry with a solid content of 32 wt %; wherein the weight ratio of the modified molecular sieve Z2, the acidified pseudo-boehmite, the alumina sol, and the kaolin was 32:18:8:42;
(2) The slurry was subjected to homogenizing, spray molding, and roasting at 470 °C for 20 min sequentially to obtain a catalyst precursor, which was mixed with water to obtain a slurry containing catalyst precursor with a solid content of 25 wt %, the slurry was then mixed with ammonium chloride, filtered, washed with 8 times of water, and dried at 120 °C for 8 h to prepare a catalytic cracking catalyst C2;
Wherein the weight ratio of the ammonium chloride to the slurry containing the catalyst precursor calculated in terms of the catalyst precursor was 5:100.

Wherein in the catalytic cracking catalyst C2, the Na⁺ content calculated in terms of Na₂O was 0.14 wt %; in the catalytic cracking catalyst C2 on a dry basis, the modified molecular sieve Z2 content was 32 wt %, the binder content was 26 wt %, and matrix material content was 42 wt %.

### Example 3

(1) The modified molecular sieve Z3, acidified pseudo-boehmite, alumina sol, a macro-porous silica-alumina material, kaolin, and water were mixed at 25 °C for 1 h to obtain a slurry with a solid content of 36 wt %; wherein the weight ratio of the modified molecular sieve Z3, the acidified pseudo-boehmite, the alumina sol, the macro-porous silica-alumina material, and the kaolin was 25:15:5.5:4:50.5;
(2) The slurry was subjected to homogenizing, spray molding, and roasting at 460 °C for 35 min sequentially to obtain a catalyst precursor, which was mixed with water to obtain a slurry containing catalyst precursor with a solid content of 20 wt %, the slurry was then mixed with ammonium chloride, filtered, washed with 5 times of water, and dried at 110 °C for 10 h to prepare a catalytic cracking catalyst C3;
Wherein the weight ratio of the ammonium chloride to the slurry containing the catalyst precursor calculated in terms of the catalyst precursor was 5:100.

Wherein in the catalytic cracking catalyst C3, the Na⁺ content calculated in terms of Na₂O was 0.07 wt %; in the catalytic cracking catalyst C3 on a dry basis, the modified molecular sieve Z3 content was 25 wt %, the binder content was 20.5 wt %, and matrix material content was 54.5 wt %.

### Example 4

(1) The modified molecular sieve Z4, acidified pseudo-boehmite, alumina sol, kaolin, halloysite, and water were mixed at 25 °C for 1 h to obtain a slurry with the solid content of 38 wt %; wherein the weight ratio of the modified molecular sieve Z4, the acidified pseudo-boehmite, the alumina sol, the kaolin, and the halloysite was 33:25:10:20:12;
(2) The slurry was subjected to homogenizing, spray molding, and roasting at 450 °C for 30 min sequentially to obtain a catalyst precursor, which was mixed with water to obtain a slurry containing catalyst precursor with a solid content of 20 wt %, the slurry was then mixed with ammonium chloride, filtered, washed with 6 times of water, and dried at 110 °C for 10 h to prepare a catalytic cracking catalyst C4;
Wherein the weight ratio of the ammonium chloride to the slurry containing the catalyst precursor calculated in terms of the catalyst precursor was 5:100.

Wherein in the catalytic cracking catalyst C4, the Na⁺ content calculated in terms of Na₂O was 0.11 wt %; in the catalytic cracking catalyst C4 on a dry basis, the modified molecular sieve Z4 content was 33 wt %, the binder content was 35 wt %, and matrix material content was 32 wt %.

### Examples 5-7

The catalytic cracking catalysts were prepared according to the method of Example 1, except that in step (1), the modified molecular sieve Z1 was replaced with the modified molecular sieve Z5-Z7, respectively, the catalytic cracking catalysts C5-C7 were prepared.

Wherein in the catalytic cracking catalyst C5, the Na⁺ content calculated in terms of Na₂O was 0.15 wt %; in the catalytic cracking catalyst C5 on a dry basis, the modified molecular sieve Z5 content was 32 wt %, the binder content was 8 wt %, and matrix material content was 60 wt %.

Wherein in the catalytic cracking catalyst C6, the Na⁺ content calculated in terms of Na₂O was 0.17 wt %; in the catalytic cracking catalyst C6 on a dry basis, the modified molecular sieve Z6 content was 32 wt %, the binder content was 8 wt %, and matrix material content was 60 wt %.

Wherein in the catalytic cracking catalyst C7, the Na⁺ content calculated in terms of Na₂O was 0.16 wt %; in the catalytic cracking catalyst C7 on a dry basis, the modified molecular sieve Z7 content was 32 wt %, the binder content was 8 wt %, and matrix material content was 60 wt %.

### Example 8

The catalytic cracking catalyst was prepared according to the method of Example 1, except that in step (1), the weight ratio of the modified molecular sieve Z1, the alumina sol, and the kaolin was replaced with 50:14:36, the catalytic cracking catalyst C8 was prepared.

Wherein in the catalytic cracking catalyst C8, the Na⁺ content calculated in terms of Na₂O was 0.18 wt %; in the catalytic cracking catalyst C8 on a dry basis, the modified molecular sieve Z1 content was 50 wt %, the binder content was 14 wt %, and matrix material content was 36 wt %.

### Example 9

The catalytic cracking catalyst was prepared according to the method of Example 1, except that in step (2), the weight ratio of the ammonium chloride to the slurry containing the catalyst precursor calculated in terms of the catalyst precursor was replaced with 1:100, the catalytic cracking catalyst C9 was prepared.

Wherein in the catalytic cracking catalyst C9, the Na⁺ content calculated in terms of Na₂O was 0.2 wt %; in the catalytic cracking catalyst C9 on a dry basis, the modified molecular sieve Z1 content was 32 wt %, the binder content was 8 wt %, and matrix material content was 60 wt %.

### Comparative Example 1

(1) The modified molecular sieve DZ1, acidified pseudo-boehmite, aluminum sol, kaolin, and water were mixed at 25 °C for 1 h to obtain a slurry with the solid content of 35 wt %; wherein the weight ratio of the modified molecular sieve DZ1, the acidified pseudo-boehmite, the alumina sol, and the kaolin was 34:10:8:48;
(2) The slurry was subjected to homogenizing, spray molding, and roasting at 450 °C for 30 min sequentially to obtain a catalyst precursor, which was mixed with water to obtain a slurry containing catalyst precursor with a solid content of 20 wt %, the slurry was then mixed with ammonium chloride, filtered, washed with 4 times of water, and dried at 105 °C for 10 h to prepare a catalytic cracking catalyst DC1;
Wherein the weight ratio of the ammonium chloride to the slurry containing the catalyst precursor calculated in terms of the catalyst precursor was 5:100.

Wherein in the catalytic cracking catalyst DC1, the Na⁺ content calculated in terms of Na₂O was 0.26 wt %; in the catalytic cracking catalyst DC1 on a dry basis, the modified molecular sieve DZ1 content was 34 wt %, the binder content was 18 wt %, and matrix material content was 48 wt %.

### Comparative Example 2

(1) The modified molecular sieve DZ2, acidified pseudo-boehmite, aluminum sol, kaolin, and water were mixed at 25 °C for 1 h to obtain a slurry with a solid content of 33 wt %; wherein the weight ratio of the modified molecular sieve DZ2, the acidified pseudo-boehmite, the alumina sol, and the kaolin was 32:15:6:47;
(2) The slurry was subjected to homogenizing, spray molding, and roasting at 470 °C for 30 min sequentially to obtain a catalyst precursor, which was mixed with water to obtain a slurry containing catalyst precursor with a solid content of 20 wt %, the slurry was then mixed with ammonium chloride, filtered, washed with 4 times of water, and dried at 120 °C for 10 h to prepare a catalytic cracking catalyst DC2;
Wherein the weight ratio of the ammonium chloride to the slurry containing the catalyst precursor calculated in terms of the catalyst precursor was 5:100.

Wherein in the catalytic cracking catalyst DC2, the Na⁺ content calculated in terms of Na₂O was 0.23 wt %; in the catalytic cracking catalyst DC2 on a dry basis, the modified molecular sieve DZ2 content was 32 wt %, the binder content was 21 wt %, and matrix material content was 47 wt %.

### Comparative Example 3

(1) The modified molecular sieve DZ3, acidified pseudo-boehmite, aluminum sol, kaolin, and water were mixed at 25 °C for 1 h to obtain a slurry with a solid content of 38 wt %; wherein the weight ratio of the modified molecular sieve DZ3, the acidified pseudo-boehmite, the alumina sol, and the kaolin was 36:13:9:42;
(2) The slurry was subjected to homogenizing, spray molding, and roasting at 430 °C for 45 min sequentially to obtain a catalyst precursor, which was mixed with water to obtain a slurry containing catalyst precursor with a solid content of 20 wt %, the slurry was then mixed with ammonium chloride, filtered, washed with 6 times of water, and dried at 100 °C for 10 h to prepare a catalytic cracking catalyst DC3;
Wherein the weight ratio of the ammonium chloride to the slurry containing the catalyst precursor calculated in terms of the catalyst precursor was 5:100.

Wherein in the catalytic cracking catalyst DC3, the Na⁺ content calculated in terms of Na₂O was 0.23 wt %; in the catalytic cracking catalyst DC3 on a dry basis, the modified molecular sieve DZ3 content was 36 wt %, the binder content was 22 wt %, and matrix material content was 42 wt %.

### Comparative Example 4

The catalytic cracking catalyst was prepared according to the method of Example 1, except that the modified molecular sieve Z1 was replaced with the modified molecular sieve DZ4, and the catalytic cracking catalyst DC4 was prepared.

Wherein in the catalytic cracking catalyst DC4, the Na⁺ content calculated in terms of Na₂O was 0.22 wt %; in the catalytic cracking catalyst DC4 on a dry basis, the modified molecular sieve DZ4 content was 34 wt %, the binder content was 18 wt %, and matrix material content was 48 wt %.

### Test Example 2

The catalytic cracking catalysts (C1-C9 and DC1-DC4) prepared in Examples 1-9 and Comparative Examples 1-4 were subjected to the reaction performance test under the following test conditions: the catalytic cracking catalysts (C1-C9 and DC1-DC4) and the Dushanzi wax oil (purchased from Petrochina Dushanzi petrochemical company) were adding into an ACE heavy oil micro-reactor respectively, and the catalytic cracking (the temperature was 500 °C, the catalyst/oil ratio was 6.5) was performed to obtain a catalytic cracking product; wherein the catalytic cracking product comprised: dry gas, liquefied gas, gasoline, diesel, heavy oil, and coke, wherein the weight ratio of the catalytic cracking catalyst to the Dushanzi wax oil was 6.5:1, the test results were listed in Table 3.

TABLE 3

| | Catalytic | Modified | Yield, % | | |
|---|---|---|---|---|---|
| | cracking | molecular | | Liquefied | |
| | catalysts | sieve | Dry gas | gas | Gasoline |
| Example 1 | C1 | Z1 | 3.21 | 23.12 | 54.12 |
| Example 2 | C2 | Z2 | 3.43 | 24.45 | 54.37 |
| Example 3 | C3 | Z3 | 3.36 | 23.87 | 54.16 |
| Example 4 | C4 | Z4 | 2.92 | 22.54 | 54.06 |
| Example 5 | C5 | Z5 | 3.65 | 23.48 | 53.99 |
| Example 6 | C6 | Z6 | 3.09 | 21.38 | 53.57 |
| Example 7 | C7 | Z7 | 3.18 | 22.75 | 53.14 |
| Example 8 | C8 | Z1 | 3.85 | 25.23 | 53.29 |
| Example 9 | C9 | Z1 | 3.05 | 20.75 | 53.59 |
| Comparative | DC1 | DZ1 | 2.85 | 19.35 | 51.93 |
| Example 1 | | | | | |
| Comparative | DC2 | DZ2 | 2.88 | 20.65 | 51.83 |
| Example 2 | | | | | |
| Comparative | DC3 | DZ3 | 3.06 | 21.08 | 52.29 |
| Example 3 | | | | | |
| Comparative | DC4 | DZ4 | 2.78 | 17.92 | 52.37 |
| Example 4 | | | | | |

TABLE 3
(Continued)

| | | | | | Conver- | Total |
|---|---|---|---|---|---|---|
| | Yield, % | | | Coke | sion | liquid |
| | | Heavy | | factor¹, | rate ², | yield ³, |
| | Diesel | oil | Coke | % | % | % |
| Example 1 | 11.52 | 4.57 | 3.46 | 0.663 | 83.91 | 88.76 |
| Example 2 | 10.21 | 3.83 | 3.71 | 0.606 | 85.96 | 89.03 |
| Example 3 | 11.57 | 3.52 | 3.52 | 0.626 | 84.91 | 89.60 |
| Example 4 | 12.08 | 5.08 | 3.32 | 0.688 | 82.84 | 88.68 |
| Example 5 | 10.98 | 3.95 | 3.95 | 0.693 | 85.07 | 88.45 |
| Example 6 | 13.21 | 5.32 | 3.43 | 0.780 | 81.47 | 88.16 |
| Example 7 | 12.55 | 4.93 | 3.45 | 0.731 | 82.52 | 88.44 |
| Example 8 | 9.82 | 3.26 | 4.55 | 0.685 | 86.92 | 88.34 |
| Example 9 | 13.78 | 5.58 | 3.25 | 0.780 | 80.64 | 88.12 |
| Comparative | 15.21 | 7.28 | 3.38 | 0.981 | 77.51 | 86.49 |
| Example 1 | | | | | | |
| Comparative | 14.47 | 6.85 | 3.32 | 0.900 | 78.68 | 86.95 |
| Example 2 | | | | | | |
| Comparative | 13.62 | 6.53 | 3.42 | 0.863 | 79.85 | 86.99 |
| Example 3 | | | | | | |
| Comparative | 15.83 | 7.82 | 3.28 | 1.016 | 76.35 | 86.12 |
| Example 4 | | | | | | |

Note:
¹coke factor = coke yield/conversion rate × (1 − conversion rate);
² conversion rate = 1 − heavy oil yield − diesel yield;
³ refers to the sum of yields of liquefied gas, gasoline, and diesel.

As can be seen from the data in Table 3, compared with the catalytic cracking catalysts prepared in Comparative Examples 1-4, the catalytic cracking catalysts prepared in Examples 1-9 have the content of Na⁺ in terms of Na₂O less than or equal to 0.2 wt %; in addition, when the catalytic cracking catalysts prepared in Examples 1-9 are used for processing wax oil, the catalysts have excellent wax oil conversion capability and cracking activity, that is, the catalysts have higher wax oil conversion rate, obviously higher gasoline yield, liquefied gas yield, and total liquid yield, and obviously lower diesel yield, heavy oil yield and coke factor.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1. A catalytic cracking catalyst comprising:
a modified molecular sieve;
a binder; and
a matrix material,
wherein the modified molecular sieve is prepared by performing modification treatment process to a Y-type molecular sieve,
wherein the modification treatment process comprises:
step a. performing rare earth ion exchange on the Y-type molecular sieve to obtain a rare earth ion exchange slurry,
step b. adding a first precipitating agent to perform a first precipitation on a part of rare earth ions in the rare earth ion exchange slurry to obtain a first precipitation slurry,
step c. subjecting the first precipitation slurry to a filtering, a first ammonium sulfate exchange, a first water washing, and a first roasting sequentially to obtain a one-exchange and one-roasting molecular sieve dry powder, and
step d. adding a second precipitating agent to perform a second precipitation on a part of rare earth ions in the one-exchange and one-roasting molecular sieve dry powder, then performing a second ammonium sulfate exchange, a second water washing, and an optional second roasting sequentially to prepare the modified molecular sieve.

2. The catalytic cracking catalyst of claim 1, wherein
the modified molecular sieve is contained in an amount of 15-50 wt %,
the binder is contained in an amount of 5-38 wt %, and
the matrix material is contained in an amount of 35-80 wt % in the catalytic cracking catalyst on a dry basis.

3. The catalytic cracking catalyst of claim 1, wherein the Y-type molecular sieve has a silica/alumina ratio within a range of 2-100.

4. The catalytic cracking catalyst of claim 1, wherein the step a, further comprises at least one of:
conditions of the rare earth ion exchange comprise: a temperature of 25-180 °C, a pH of 2.8-6.5, a time of 0.3-3.5 h; or
the rare earth ion exchange comprises: mixing the Y-type molecular sieve with water, and then adding a soluble rare earth salt to perform the rare earth ion exchange.

5. The catalytic cracking catalyst of claim 1, wherein the step b further comprises at least one of:
a used amount of the first precipitating agent satisfies a molar ratio of the rare earth ions with a content of 1-4 wt % in the Y-type molecular sieve via the first precipitation; or
the first precipitating agent is at least one selected from the group consisting of ammonium oxalate, ammonium carbonate, ammonium bicarbonate, aqueous ammonia, urea, and ammonium acetate; or
conditions of the first precipitation comprise a temperature of 25-180 °C and a time of 0.1-5 h.

6. The catalytic cracking catalyst of claim 1, wherein in the step c, the first ammonium sulfate exchange further comprises at least one of:
exchanging a filtered product with a first aqueous ammonium sulfate solution; or
conditions of the first ammonium sulfate exchange comprise: a temperature of 15-150 °C and a time of 0.1-5 h; or
in the first water washing, a used amount of water is 1-8 times a weight of the Y-type molecular sieve; or
conditions of the first roasting comprise an atmosphere of 100% water vapor, a temperature of 400-700 °C, and a time of 0.1-5 h.

7. The catalytic cracking catalyst of claim 1, wherein the step d further comprises at least one of:
a used amount of the second precipitating agent satisfies a molar ratio of the rare earth ions with a content of 0.5-3 wt % in the one-exchange and one-roasting molecular sieve dry powder via the second precipitation; or
the second precipitating agent is at least one selected from the group consisting of: ammonium oxalate, ammonium carbonate, ammonium bicarbonate, aqueous ammonia, urea, and ammonium acetate; or
conditions of the second precipitation comprise: a temperature of 15-40 °C and a time of 0.1-5 h; or
the second ammonium sulfate exchange comprises exchanging a second precipitation product with a second aqueous ammonium sulfate solution; or
conditions of the second ammonium sulfate exchange comprise: a temperature of 20-85 °C and a time of 0.1-5 h; or
in the second water washing, a used amount of water is 1-8 times a weight of the one-exchange and one-roasting molecular sieve dry powder; or
conditions of the second roasting comprise: an atmosphere of 20-100% water vapor, a temperature of 400-700 °C, and a time of 0.1-10 h; or
before the second precipitation, blending the one-exchange and one-roasting molecular sieve dry powder with water, wherein a weight ratio of the one-exchange and one-roasting molecular sieve dry powder to water is within a range of 1:(1.5-30).

8. The catalytic cracking catalyst of claim 1, further comprising at least one of:
the binder is at least one selected from the group consisting of: an aluminum sol, an acidified pseudo-boehmite, an acidic silica sol, and a phospho-alumina sol; or
the matrix material is at least one selected from the group consisting of: kaoline, halloysite, porous stone, diatomaceous earth, sepiolite, macro-porous alumina, boehmite, and a macro-porous silica alumina material.

9. The catalytic cracking catalyst of claim 1 further comprising at least one of:
the modified molecular sieve has at least one of:
an SO₄²⁻ content less than or equal to 1 wt %,
a Na⁺ content calculated in terms of Na₂O less than or equal to 1.2 wt %;
a RE³⁺ content calculated in terms of RE₂O₃ more than or equal to 5 wt %,
a C/C₀ ratio more than or equal to 55; or
the catalytic cracking catalyst has a Na⁺ content calculated in terms of Na₂O less than or equal to 0.2 wt %.

10. A method for preparing a catalytic cracking catalyst comprising:
(1) mixing a modified molecular sieve, a binder, a matrix material, and water to obtain a slurry;
(2) subjecting the slurry to homogenizing, molding, and a third roasting sequentially to obtain a catalyst precursor, performing a sodium reduction treatment on the catalyst precursor to prepare the catalytic cracking catalyst; and
preparing the modified molecular sieve is prepared by performing modification treatment to a Y-type molecular sieve, and the modification treatment comprises:
step a. performing rare earth ion exchange on the Y-type molecular sieve to obtain a rare earth ion exchange slurry,
step b. adding a first precipitating agent to perform a first precipitation on a part of rare earth ions in the rare earth ion exchange slurry to obtain a first precipitation slurry,
step c. subjecting the first precipitation slurry to a filtering, a first ammonium sulfate exchange, a first water washing, and a first roasting sequentially to obtain a one-exchange and one-roasting molecular sieve dry powder, and
step d. adding a second precipitating agent to perform a second precipitation on a part of rare earth ions in the one-exchange and one-roasting molecular sieve dry powder, then sequentially performing a second ammonium sulfate exchange, a second water washing, and an optional second roasting to prepare the modified molecular sieve.

11. The method of claim 10, wherein the method further comprises at least one of:
in step (1), at least one of:
a weight ratio of the modified molecular sieve, the binder, and the matrix material is (15-50):(5-38):(35-80), or
the slurry has a solid content within a range of 25-50 wt %; or
in step (2), at least one of:
conditions of the third roasting comprise a temperature of 400-550° °C; a time of 0.1-5 h,
the sodium reduction treatment comprises: subjecting an ammonium salt and the slurry containing the catalyst precursor to mixing, filtering, a third water washing, and drying sequentially to prepare the catalytic cracking catalyst,
the modified molecular sieve has a SO₄²⁻ content less than or equal to 1 wt %,
the modified molecular sieve has a Na⁺ content calculated in terms of Na₂O less than or equal to 1.2 wt %,
the modified molecular sieve has a RE³⁺ content calculated in terms of RE₂O₃ more than or equal to 5 wt %,
the modified molecular sieve has a C/C₀ ratio more than or equal to 55, or
the catalytic cracking catalyst has a Na⁺ content calculated in terms of Na₂O less than or equal to 0.2 wt %.

12. (canceled)

13. A method for processing wax oil comprising:
carrying out catalytic cracking on the wax oil to obtain catalytic cracking products when a catalyst is present,
wherein the catalytic cracking products comprise dry gas, liquefied gas, gasoline, diesel, heavy oil, and coke, and
wherein the catalyst is selected from the catalytic cracking catalyst of claim 1 or the catalytic cracking catalyst produced with the method of claim 10.

14. The method of claim 13, wherein a weight ratio of the catalyst to the wax oil is (4-12):1.

15. The catalytic cracking catalyst of claim 3, wherein the Y-type molecular sieve is at least one selected from the group consisting of a NaY molecular sieve, a NaHY molecular sieve, a NaUSY molecular sieve, a NaREHY molecular sieve, and a NaREUSY molecular sieve.

16. The catalytic cracking catalyst of claim 4, further comprises at least one of:
a weight ratio of the Y-type molecular sieve to water is 1:(1.5-30);
the soluble rare earth salt calculated in terms of RE₂O₃ is contained in the Y-type molecular sieve on a dry basis in an amount of 1-20 wt %; or
the soluble rare earth salt is selected from at least one of a chlorate and/or nitrate containing at least one of a rare earth elements.

17. The catalytic cracking catalyst of claim 6 further comprises at least one of:
a weight ratio of the first aqueous ammonium sulfate solution calculated in terms of ammonium sulfate to the Y-type molecular sieve is (5-50):100; or
a concentration of ammonium sulfate in the first aqueous ammonium sulfate solution is within a range of 20-400 g/L.

18. The catalytic cracking catalyst of claim 7 further comprises at least one of:
a weight ratio of the second aqueous ammonium sulfate solution calculated in terms of ammonium sulfate to the one-exchange and one-roasting molecular sieve dry powder is (5-50):100; or
a concentration of ammonium sulfate in the second aqueous ammonium sulfate solution is within a range of 20-400 g/L.

19. The method of claim 11, further comprising at least one of:
a solid content of the slurry containing the catalyst precursor is within a range of 10-40 wt %; or
a weight ratio of the ammonium salt to the slurry containing the catalyst precursor calculated in terms of the catalyst precursor is (1-10):100; or
in the third water washing, a used amount of water is 1-8 times the weight of the catalytic cracking catalyst.
